(19) United States
(12) Patent Application Publication
(10) Pub. No.: US 2026/0134733 A1
(43) Pub. Date: May 14, 2026

(54) Coin Checking and Sorting Device

(71) Applicant: Lynda Boysel, Annville, PA (US)

(72) Inventor: Lynda Boysel, Annville, PA (US)

(21) Appl. No.: 19/018,056

(22) Filed: Jan. 13, 2025

Related U.S. Application Data
(60) Provisional application No. 63/719,451, filed on Nov. 12, 2024.

(51) Int. Cl. G07D 5/00; G07D 3/14; G07D 5/02; G07D 5/04

(52) U.S. Cl. CPC G07D 5/005; G07D 3/14; G07D 5/02; G07D 5/04; G07D 2205/00

(57) ABSTRACT

A coin checking and sorting device is provided. The device comprises a hopper mechanism capable of handling various coin sizes in bulk, equipped with adjustable guides, sensors, and a diverting mechanism to ensure proper alignment and eject irregular coins. A dual-sided imaging scanner employs OCR and machine learning algorithms to detect coin details, anomalies, and errors, supported by advanced lighting for optimal image quality. A servo-driven sorting mechanism directs coins into separate baskets based on standard or flagged characteristics, with optional rolling capabilities for bank-ready storage. A cloud-connected database provides real-time updates and comprehensive metadata logging, including condition, rarity, and value, with anomalies cross-verified against known standards. Additional features include a weight verification system, customizable alerts, and high-resolution display options for detailed review, enabling efficient, accurate, and user-focused coin processing.

### CROSS-REFERENCE TO RELATED APPLICATION

The present application claims priority to, and the benefit of, U.S. Provisional Application No. 63/719,451, which was filed on Nov. 12, 2024, and is incorporated herein by reference in its entirety.

### FIELD OF THE INVENTION

The present invention relates generally to the field of currency sorting. More specifically, the present invention relates to a coin checking and sorting device that simplifies coin identification and categorization through features like a bulk-handling hopper, a dual-sided imaging scanner with OCR and machine learning algorithms, and a servo-driven sorting mechanism for precise routing. Additional capabilities include a cloud-connected database for real-time valuation, a weight verification system, and customizable alerts, providing accurate and efficient coin processing for collectors and institutional users. Accordingly, the present disclosure makes specific reference thereto. Nonetheless, it is to be appreciated that aspects of the present invention are also equally applicable to other like applications, devices, and methods of manufacture.

### BACKGROUND

Coin collecting is a widely enjoyed pastime and a critical activity for financial institutions and businesses involved in cash handling. However, the process of accurately identifying and categorizing coins presents notable challenges. One common issue is the presence of mis-stamped or otherwise anomalous coins, which can hold significant monetary or collectible value. Identifying such coins requires close examination and specialized knowledge, which many collectors lack. Furthermore, improper identification can result in misleading valuations, potentially leading to financial losses for collectors and professionals alike. For businesses such as banks, which process large volumes of coins daily, the task of manually sorting and identifying anomalies is time-consuming and labor-intensive. Even for dedicated collectors who enjoy examining their coins, the lack of an efficient and systematic process can make it difficult to detect rare or valuable pieces in their collections.

The time and effort involved in reviewing coins manually further complicates the process. For collectors, this inefficiency may diminish the joy of the hobby, as they often do not know what to look for when reviewing their coins. For commercial users, such as banks or retail operations, improper sorting of coins can disrupt operations and necessitate costly interventions to ensure accuracy. The need for expertise often forces individuals to hire specialists to verify the authenticity and value of their coins, adding expense and inconvenience to the process. With no standardized method for sorting and identifying coins efficiently, there is a growing demand for a solution that addresses these limitations while being accessible to both casual users and professional entities.

Therefore, there exists a long-felt need in the art for a coin checking and sorting device that simplifies the detection of mis-stamped coins. There also exists a long-felt need in the art for a system that reduces the manual labor and time involved in sorting coins for collectors and commercial users. Moreover, there exists a long-felt need in the art for a device that integrates scanning and database technology to provide detailed coin descriptions and enable efficient record-keeping.

The subject matter disclosed and claimed herein, in one embodiment thereof, comprises a coin checking and sorting device designed to streamline the identification, scanning, and categorization of coins for both casual collectors and professional users. The device comprises a hopper mechanism capable of handling various coin sizes in bulk, equipped with adjustable guides, sensors, and a diverting mechanism to ensure proper alignment and eject irregular coins. A dual-sided imaging scanner employs OCR and machine learning algorithms to detect coin details, anomalies, and errors, supported by advanced lighting for optimal image quality. A servo-driven sorting mechanism directs coins into separate baskets based on standard or flagged characteristics, with optional rolling capabilities for bank-ready storage. A cloud-connected database provides real-time updates and comprehensive metadata logging, including condition, rarity, and value, with anomalies cross-verified against known standards. Additional features include a weight verification system, customizable alerts, and high-resolution display options for detailed review, enabling efficient, accurate, and user-focused coin processing.

In this manner, the coin checking and sorting device of the present invention accomplishes all the forgoing objectives by providing a comprehensive coin sorting and scanning system that leverages a hopper-based input and advanced scanning technology to identify and sort coins into ‘regular’ and ‘review’ baskets based on their potential value or abnormalities. The integration with a wireless database ensures accurate record-keeping and allows users to store detailed information about scanned coins. By eliminating unnecessary manual examination of normal coins and streamlining the identification of potentially valuable mis-stamped coins, the coin checking and sorting device significantly saves time and effort for collectors and financial institutions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a coin checking and sorting device. The coin checking and sorting device is designed to enhance the efficiency and accuracy of coin identification and sorting for both collectors and institutional users. The device comprises a hopper mechanism that serves as the entry point for coins, accommodating various sizes and bulk quantities to ensure smooth processing. The hopper features adjustable coin guides that filter out coins of unsuitable sizes, such as foreign coins or tokens, by using spacing rollers or plates to align coins in a single file. Sensors embedded at the hopper entryway monitor coin dimensions and activate a diverting mechanism to eject irregular coins into a reject bin, reducing the likelihood of scanning errors. High-torque stepper motors ensure consistent coin movement while preventing jams.

Coins progress to a high-resolution dual-sided imaging scanner, which captures detailed images of both the obverse and reverse sides. This scanner employs optical character recognition (OCR) technology to accurately read dates, mint marks, and inscriptions, while advanced machine-learning algorithms detect anomalies such as mis-stamps, double-dies, and off-center strikes. Diffused LED lighting minimizes glare and ensures consistent image quality, supporting precise analysis.

After scanning, the device utilizes a sorting mechanism powered by a servo motor and actuator arm to direct coins into either a “Regular” basket or a “Review” basket based on scanner results. Coins deemed standard are placed in the “Regular” basket, which includes an optional rolling mechanism for organizing coins into tubes compatible with standard rolling paper wrappers. Coins flagged for further inspection are deposited into a “Review” basket lined with non-abrasive materials to prevent damage.

A cloud-connected database provides comprehensive coin information, updated in real time to reflect market trends and discoveries. Each scanned coin is logged with metadata, including mint year, dimensions, weight, and estimated value, which is cross-referenced against database standards using advanced algorithms to detect abnormalities. Scanning results, including high-resolution images and detailed metadata, are displayed on a built-in electronic screen or accessed via a companion app, offering users historical insights, rarity rankings, and valuation data. Alerts for rare or high-value coins are delivered through LED indicators or on-screen notifications and can be customized to suit user preferences.

The device also features a weight verification system that uses embedded load cells to measure coin weight with precision, comparing results against database standards to detect counterfeit or improperly minted coins. Additional detection capabilities include identifying misaligned designs, excessive wear inconsistent with a coin's mint year, and surface defects like cracks, laminations, or die cuts. High-resolution images of all scanned coins are saved for record-keeping and sharing. The device offers customizable configurations, ensuring targeted coin sorting and analysis for diverse user needs.

Accordingly, the coin checking and sorting device of the present invention is particularly advantageous as it provides a comprehensive coin sorting and scanning system that leverages a hopper-based input and advanced scanning technology to identify and sort coins into ‘regular’ and ‘review’ baskets based on their potential value or abnormalities. The integration with a wireless database ensures accurate record-keeping and allows users to store detailed information about scanned coins. By eliminating unnecessary manual examination of normal coins and streamlining the identification of potentially valuable mis-stamped coins, the coin checking and sorting device significantly saves time and effort for collectors and financial institutions.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of the components of one potential embodiment of a coin checking and sorting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a coin checking and sorting device that simplifies the detection of mis-stamped coins. There also exists a long-felt need in the art for a system that reduces the manual labor and time involved in sorting coins for collectors and commercial users. Moreover, there exists a long-felt need in the art for a device that integrates scanning and database technology to provide detailed coin descriptions and enable efficient record-keeping.

The present invention, in one exemplary embodiment, is comprised of a coin checking and sorting device. The coin checking and sorting device is designed to improve the efficiency and precision of coin identification and sorting for both collectors and institutional users. It includes a hopper mechanism that serves as the coin entry point, accommodating various sizes and bulk quantities for uninterrupted processing. The hopper incorporates adjustable coin guides that exclude coins of inappropriate sizes, such as foreign coins or tokens, using spacing rollers or plates to align coins in a single file. Sensors positioned at the hopper entryway measure coin dimensions and activate a diverting mechanism to redirect irregular coins to a reject bin, minimizing scanning errors. High-torque stepper motors ensure steady coin movement and prevent jamming.

Coins are then processed by a high-resolution dual-sided imaging scanner that captures detailed images of both surfaces. This scanner utilizes optical character recognition (OCR) to accurately detect dates, mint marks, and inscriptions, while advanced machine-learning algorithms identify anomalies such as mis-stamps, double-dies, and off-center strikes. Diffused LED lighting reduces glare and ensures consistent image quality for precise analysis.

Following the scanning process, the device uses a sorting mechanism driven by a servo motor and actuator arm to route coins into either a “Regular” basket or a “Review” basket based on the scanning results. Coins classified as standard are placed in the “Regular” basket, which can include an optional rolling mechanism for arranging coins into tubes compatible with standard paper wrappers. Coins requiring further review are deposited into a “Review” basket lined with non-abrasive materials to prevent any damage.

A cloud-connected database provides extensive coin information, updated in real-time to reflect current market trends and discoveries. Metadata for each scanned coin, including mint year, dimensions, weight, and estimated value, is logged and cross-referenced against database standards using advanced algorithms to detect irregularities. Scanning results, including high-resolution images and detailed metadata, are displayed on an integrated screen or accessed via a companion app, offering users insights into historical data, rarity rankings, and valuations. Alerts for rare or valuable coins are delivered through LED indicators or on-screen notifications, which can be customized to user preferences.

The device also includes a weight verification system with embedded load cells that measure coin weight with high precision, comparing the data against database standards to detect counterfeit or improperly minted coins. Additional detection capabilities include identifying misaligned designs, unusual wear inconsistent with the coin's mint year, and surface defects such as cracks, laminations, or die cuts. High-resolution images of scanned coins are saved for record-keeping and sharing, and the device offers customizable configurations for targeted sorting and analysis.

The coin checking and sorting device provides a comprehensive coin scanning and sorting solution that combines a hopper-based input system with advanced scanning technology to identify and sort coins into “Regular” and “Review” baskets based on their characteristics and potential value. Its integration with a wireless database supports accurate record-keeping and detailed documentation of scanned coins. By automating the sorting of standard coins and highlighting potentially valuable mis-stamped coins, the device significantly reduces the time and effort required for manual examination, benefiting both collectors and financial institutions.

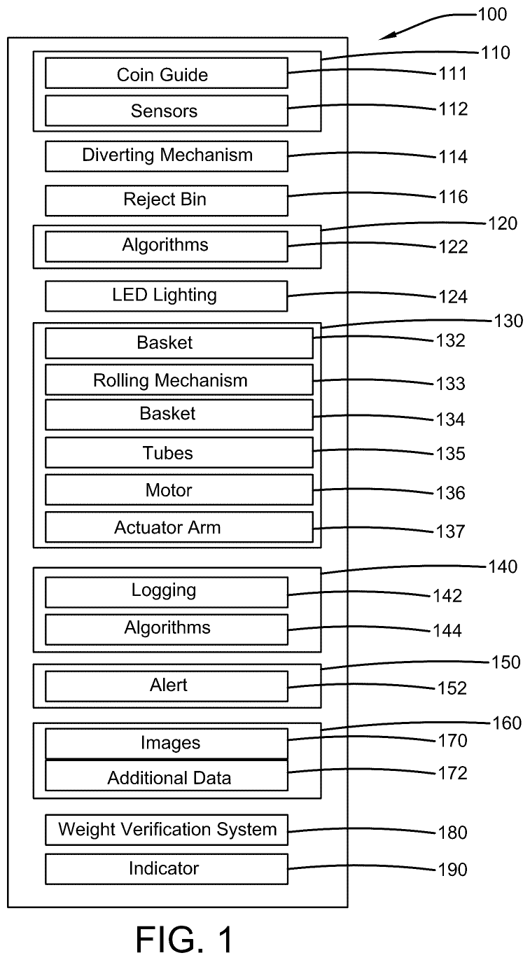

Referring initially to the drawings, FIG. 1 illustrates a graphical view of components of one potential embodiment of a coin checking and sorting device 100 of the present invention in accordance with the disclosed architecture. The coin checking and sorting device 100 is designed to simplify and enhance the process of coin identification and sorting, making it invaluable for both hobbyist collectors and institutional users. The device 100 is comprised of a hopper mechanism 110 that serves as the entry point for coins. The hopper 110 is specifically engineered to handle a variety of coin sizes and accommodate bulk quantities, ensuring efficient processing without bottlenecks. The hopper 110 is preferably made from durable, anti-static, food-grade plastic or lightweight aluminum. Additionally, adjustable coin guides 111 within the hopper enable the user to filter out coins that are too large or too small, such as foreign coins or tokens, reducing the likelihood of scanning errors. More specifically, the coin guides 111 may employ spacing rollers or plates to channel coins into a single-file alignment, ensuring smooth progression into the scanner 120. These rollers are driven by small, high-torque stepper motors that maintain consistent speed and prevent coin jams. Sensors 112 embedded in the hopper entryway work in conjunction with the coin guides 111, monitoring the size and shape of each coin. If an irregular coin is detected, the sensors 112 trigger a diverting mechanism 114 to eject the coin into a reject bin 116 before it reaches the scanner 120. This system minimizes errors and ensures the integrity of the scanning and sorting process.

Once coins are loaded into the hopper 110, they are processed through a high-resolution, dual-sided imaging scanner 120 that captures detailed images of the obverse, reverse, and the rim of each coin in super high definition at a microscopic level. This comprehensive scanning process ensures that even the smallest imperfections or markings are accurately recorded. The scanner 120 employs advanced optical character recognition (OCR) technology to precisely read dates, mint marks, inscriptions, and other identifying details, regardless of wear or surface degradation. Additionally, the microscopic imaging of the rim allows for the detection of edge anomalies such as reeding errors, planchet flaws, and subtle die imperfections.

The system integrates advanced image analysis algorithms 122, as illustrated in FIG. 1, trained through machine learning models to identify anomalies such as mis-stamps, double-dies, off-center strikes, rim cuds, and other rare minting errors with exceptional accuracy. The imaging scanner's multi-angle capability ensures that no part of the coin's surface or edge is left unexamined. To enhance image clarity and consistency, the device 100 is equipped with diffused LED lighting 124, strategically positioned to minimize glare and shadows. This lighting system ensures uniform illumination of the obverse, reverse, and rim, allowing for the highest possible image quality, even at microscopic magnification levels.

After scanning, the device 100 employs a sorting mechanism 130. The sorting mechanism 130 is responsible for directing scanned coins into one of two baskets: the “Regular” basket 132 or the “Review” basket 134, as seen in FIG. 1. The sorting mechanism 130 is comprised of a servo motor 136 that powers an actuator arm 137. This actuator 137 is controlled by data from the scanning system 120, which analyzes each coin's characteristics and determines its pathway. Coins identified as standard are deposited into the “Regular” basket 132 by the actuator 137, while those flagged for potential value or errors are routed to the “Review” basket 134 by the actuator 137. A servo-driven actuator ensures precise routing based on the scanner's analysis. The “Regular” basket 132 may include an optional rolling mechanism 133 for automatic coin organization into tubes 135. These tubes 135 are compatible with standard rolling paper wrappers, facilitating seamless integration with existing bank and storage processes. Coins requiring further inspection are placed in the “Review” basket, which is lined with or made from soft, non-abrasive materials to prevent scratches or damage.

The device 100 is also comprised of a cloud-connected database 140 that provides comprehensive information on coins from various regions and time periods. This database 140 is updated in real time to ensure that the database 140 remains accurate and reflects the latest market trends and discoveries. Each scanned coin is logged 142 into the database 140 with detailed metadata, including year of minting, mint mark (if any), physical dimensions, weight comparison against known standards, and estimated value based on condition and rarity. Advanced algorithms 144 cross-reference the scanned coin's data against the database 140 to detect even subtle abnormalities. Additionally, the device 100 is capable of comparing the scanned coin to precise reference specifications, including exact measurements of diameter, thickness, and weight, to determine what the coin should look like based on standards for its minting year and origin. These algorithms 144 are designed to recognize any deviations or discrepancies in physical attributes beyond merely matching the coin to a database of known issues, thereby enhancing the accuracy of anomaly detection and authentication.

A built-in electronic display 150 or a companion desktop/mobile application 160 displays real-time scanning results, including high-resolution images 170 of flagged coins. Users can review these images 170, along with additional data 172 such as historical information, rarity rankings, and suggested valuations.

To further enhance accuracy, the coin checking and sorting device includes a weight verification system 180 that utilizes embedded load cells to measure the weight of each coin with high precision. This weight data is compared against database 140 standards to identify counterfeit or improperly minted coins. Additionally, the device 100 saves high-resolution images 170 of all scanned coins, which can be used for record-keeping, sharing, or printing.

Using the image scanner 120, the device 100 may also detect misaligned design elements, excessive wear inconsistent with the coin's year, and surface features like cracks, laminations, or die cuts. Notifications of rare or high-value coins are delivered via an LED indicator 190 or on-screen alert 152. Users can also customize these alerts 152 to prioritize specific interests, such as particular mint years or error types.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “coin checking and sorting device” and “device” are interchangeable and refer to the coin checking and sorting device 100 of the present invention.

Notwithstanding the forgoing, the coin checking and sorting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the coin checking and sorting device 100 as shown in the FIGS. are for illustrative purposes only, and that many other sizes and shapes of the coin checking and sorting device 100 are well within the scope of the present disclosure. Although the dimensions of the coin checking and sorting device 100 are important design parameters for user convenience, the coin checking and sorting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A coin checking and sorting device comprising:
a hopper;
a coin guide;
a sensor;
a diverting mechanism;
a reject bin;
an image scanner;
an algorithm for coin analysis;
an LED light;
a sorting mechanism comprised of an actuator arm; and
a database configured to log a metadata associated with a scanned coin.

2. The coin checking and sorting device of claim 1, wherein the coin guide is comprised of an adjustable coin guide.

3. The coin checking and sorting device of claim 1, wherein the sensor detects a size of the scanned coin.

4. The coin checking and sorting device of claim 1, wherein the sensor detects a shape of the scanned coin.

5. The coin checking and sorting device of claim 1, wherein the diverting mechanism operates in response to a signal from the sensor.

6. The coin checking and sorting device of claim 1, wherein the image scanner performs a dual-sided image scan of the scanned coin.

7. The coin checking and sorting device of claim 1, wherein the algorithm for coin analysis is comprised of an optical character recognition for analyzing a coin inscription of the scanned coin.

8. The coin checking and sorting device of claim 1, wherein the actuator arm is driven by a motor.

9. A coin checking and sorting device comprising:
a hopper comprised of a coin guide and a sensor for aligning and detecting an irregular version of a coin;
a diverting mechanism operable to route the irregular version of the coin to a reject bin;
an image scanner configured to analyze the coin using an algorithm and an LED light;
a sorting mechanism comprised of a motor-driven actuator arm for directing the coin to predefined basket; and
a display for presenting a scanning result and an alert.

10. The coin checking and sorting device of claim 9, wherein the alert is comprised of a coin flagged for a specific characteristic.

11. The coin checking and sorting device of claim 9 further comprised of a mobile application.

12. The coin checking and sorting device of claim 9, wherein the mobile application displays the scanning result.

13. The coin checking and sorting device of claim 9, wherein the mobile application displays an additional coin data.

14. The coin checking and sorting device of claim 9 further comprised of a rolling mechanism.

15. The coin checking and sorting device of claim 9 further comprised of a database.

16. A coin checking and sorting device comprising:
a hopper comprised of a coin guide, a sensor, and a diverting mechanism;
an image scanner utilizing an algorithm and an LED light for dual-sided imaging;
a sorting mechanism comprised of an actuator arm for directing a coin into a first basket and a second basket;
a database for logging a date of the coin and cross-referencing an information about the coin; and
a weight verification system configured to measure a weight of the coin.

17. The coin checking and sorting device of claim 16, wherein the sorting mechanism routes the coin into the first basket or the second basket.

18. The coin checking and sorting device of claim 16, wherein the weight verification system utilizes is comprised of an embedded load cell to measure a weight of the coin.

19. The coin checking and sorting device of claim 16, wherein the database logs a metadata.

20. The coin checking and sorting device of claim 16, wherein the metadata is comprised of a dimension of the coin, a mint year of the coin, or an estimated value of the coin.
